(19) United States
(12) Patent Application Publication
(10) Pub. No.: US 2001/0002157 A1
(43) Pub. Date: May 31, 2001

(54) A DATA STORAGE DEVICE HAVING A LOAD-BEARING CARTRIDGE-ACCESS DOOR

(76) Inventors: MAKI WAKITA, SAITAMA (JP); KATSUTOSHI MUKAIJIMA, TOKYO (JP); SHOJI TAKAHASHI, SAITAMA (JP)

Correspondence Address: WOODCOCK WASHBURN KURTZ, MACKIEWICZ & NORRIS LLP, ONE LIBERTY PLACE - 46TH FLOOR, PHILADEPHIA, PA, 19103

(21) Appl. No.: 09/272,107

(22) Filed: Mar. 19, 1999

Related U.S. Application Data
(60) Provisional application No. 60/106,219, filed on Oct. 30, 1998.

(30) Foreign Application Priority Data
Mar. 20, 1998 (JP) 71590/1998

(51) Int. Cl. G11B 17/02

(52) U.S. Cl. 360/97.01

(57) ABSTRACT

A data storage device has an external casing comprising an opening which allows access to the components within the casing by a data storage cartridge. A door covers the opening when a data storage cartridge is not installed in the device. The construction and placement of the door allow the door to function as a structural element, thus enhancing the ability of the data storage device to withstand externally-applied loads without deformation or damage. Additionally, the door functions as a guide-piece for the data storage cartridge as it is inserted into the storage device. Furthermore, the door accomplishes these functions without requiring any increase in the height or width of the device.

### BACKGROUND OF THE INVENTION

Portable electronic devices for the storage and retrieval of information, such as notebook computers, have become smaller and more lightweight in recent years. As a result of this trend, the use of memory cards has become popular. Memory cards are used as a storage medium for data, and can readily be inserted into and removed from most portable information storage and retrieval devices.

Most memory cards employ semiconductors for the storage of data. These types of cards, however, are relatively expensive and possess relatively low data-storage capacity. These limitations have lead to the development of data storage devices which utilize a magnetic storage medium placed inside a memory-card-type cartridge.

To increase the portability of information storage and retrieval devices, magnetic data storage devices are being produced in increasingly smaller sizes. In particular, thinner designs are continually being sought due to the direct relationship between thickness and portability. Such reductions in size, however, reduce the structural stiffness of the storage device. This reduction in stiffness makes deformation of the device more likely upon the application of external forces, thereby increasing the chances for damage to the device itself or to the information stored in the device. Thus, a need exists for a small, thin magnetic storage device with sufficient structural stiffness to resist externally-applied forces without undergoing significant deformation.

### SUMMARY OF THE INVENTION

The present invention is directed to a data storage device comprising a casing which encloses the following components: a disk-drive motor, a head-drive motor, read/write heads for storing and retrieving data from a magnetic disk medium, and an integrated circuit board for controlling the operation of the device.

The casing is equipped with an opening which facilitates access to the internal components by a data storage cartridge containing the aforementioned magnetic disk medium. A cartridge-access door covers the opening when a data storage cartridge is not installed in the device, thus isolating the internal components from dust and other foreign objects. The door is hinged and spring-loaded such that insertion of a data cartridge causes the door to rotate into a retracted position within the casing, thus allowing access to the interior of the casing. Additionally, while in the retracted position, the door forms a surface which guides the cartridge into its correct position within the data storage device.

The construction of the cartridge access door, and the positioning of the door in relation to the casing are such that the door functions as a structural element which enhances the rigidity of the data storage device. This enhanced rigidity allows the device to withstand externally-applied loading without experiencing substantial deformation or damage.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show an embodiment that is presently preferred, it being understood, however, that the invention is not limited to the specific methods and instrumentalities disclosed. In the drawings:

FIG. 1 is an isometric view of a data storage device according to the present invention, and a data storage cartridge for use in the device;

FIG. 2 is an isometric view of the storage device of FIG. 1 with the upper cover removed;

FIG. 3 is cross-sectional view of the storage device of FIG. 1 along the line C-C of FIG. 2;

FIG. 4 is a partial enlargement of the cross-section of FIG. 3 showing the area marked as section D;

FIG. 4A is an isometric view of the cartridge-access-opening door of the device of FIG. 1;

FIG. 5 shows the area illustrated in FIG. 4 with a data storage cartridge partially inserted;

FIG. 6 is a partial enlargement of the cross-section of FIG. 3 showing the disk-drive motor of the storage device;

FIG. 7 is a partial enlargement of the cross-section of FIG. 3 showing the head-drive motor of the storage device;

FIG. 8 is a partial enlargement of the cross-section of FIG. 7 showing the integrated circuit of the storage device;

FIG. 9 is an exploded view of the device of FIG. 1;

FIG. 10 is a partial enlargement of the cross-section of FIG. 3 showing the head-drive motor of the storage device; and

FIG. 11 is a partial enlargement of the cross-section of FIG. 10 showing the integrated circuit of the storage device.

### DETAILED DESCRIPTION OF PREFERRED EMBODIMENT

The present invention provides a data storage device for use with portable electronic devices. Throughout this description, a preferred embodiment of the invention is described in connection with a data storage device of a particular size. These dimensions are presented for exemplary purposes only. Accordingly, the invention should not be limited to the particular embodiment shown, as the invention contemplates application to other types and configurations of data storage devices.

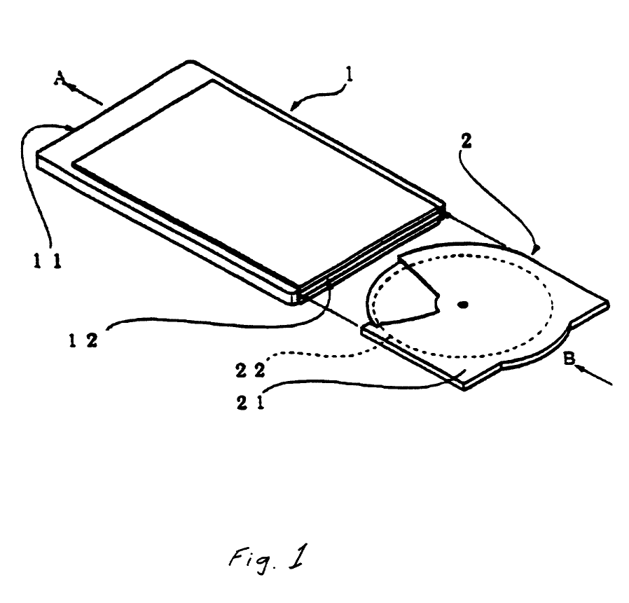

FIG. 1 is an overall illustration of a data storage device 1 and a removable data storage cartridge 2 suitable for use in the storage device. Device 1 is equipped with an opening 12 through which data storage cartridge 2 can be inserted and removed.

Data storage cartridge 2 comprises a disk-shaped storage medium 22 enclosed by a casing 21, whereby the medium rotates freely within the casing.

Data storage device 1 can be inserted into the main body of a computer device by inserting the storage device into an appropriately-sized slot, in the direction indicated by arrow A in FIG. 1. Device 1 is equipped with a connector 11 which allows the device to electronically interface with the computer.

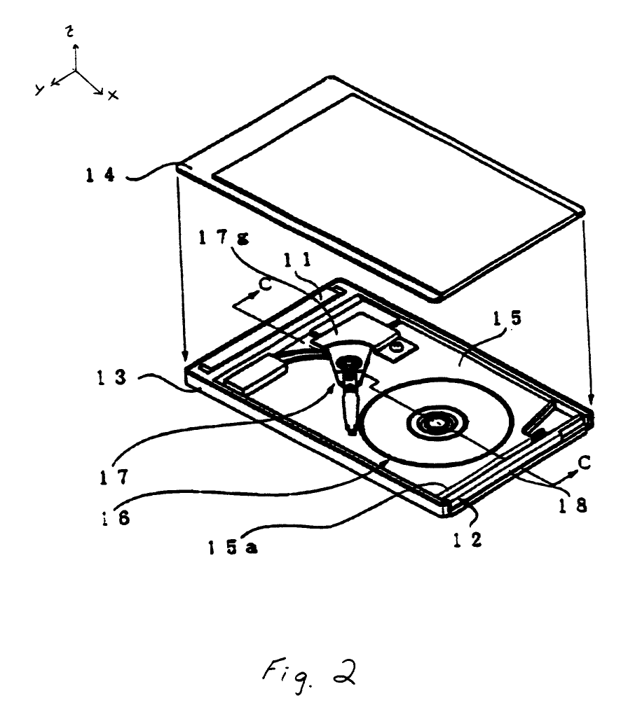

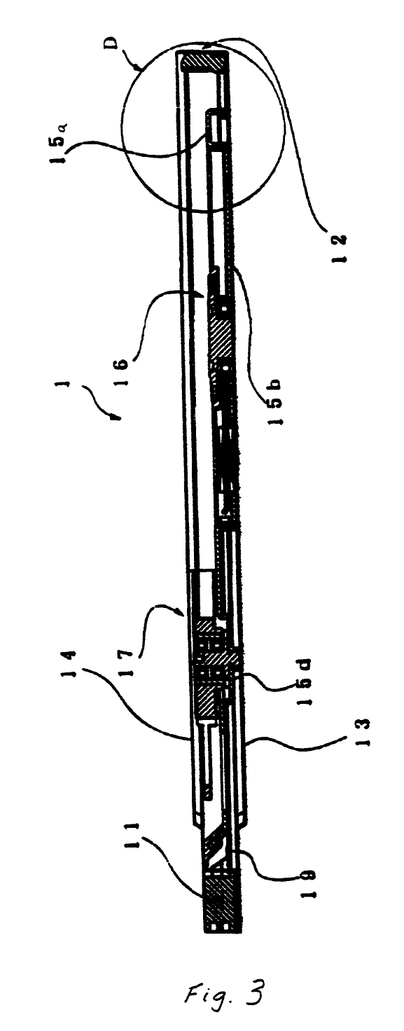

FIGS. 2 and 3 illustrate the general concept of data storage device 1. Storage device 1 is covered by a casing. Preferably, the casing has the shape and dimensions conforming to the PCMCIA Type-II form factor, i.e., about 86 mm long, 54 mm wide, and 5 mm thick The casing comprises an upper casing 14 and a lower casing 13.

A frame 15 is located within the casing about mid-way between upper casing 14 and lower casing 13. A disk drive motor 16 and a read/write head 17 are mounted to the upper surface of frame 15. A circuit board 19 is attached to the lower surface of frame 15 through an insulating sheet (not shown). A movable door 18 is coupled to opening 12 to isolate the interior of data storage device 1 when data storage cartridge 2 is not installed, and to increase the structural stiffness of the device.

As indicated above, frame 15 provides a means for mounting the primary components of data storage device 1. Mounting the primary components on a single frame simplifies the structure of the device and reduces the overall part count. Additionally, as explained below, the geometry of frame 15 minimizes the overall dimensions of data storage device 1. Furthermore, since frame 15 spans substantially the entire length and width of device 1, the frame provides resistance to externally-applied bending forces which, absent the structural stiffness afforded by the frame, could damage data storage device 1.

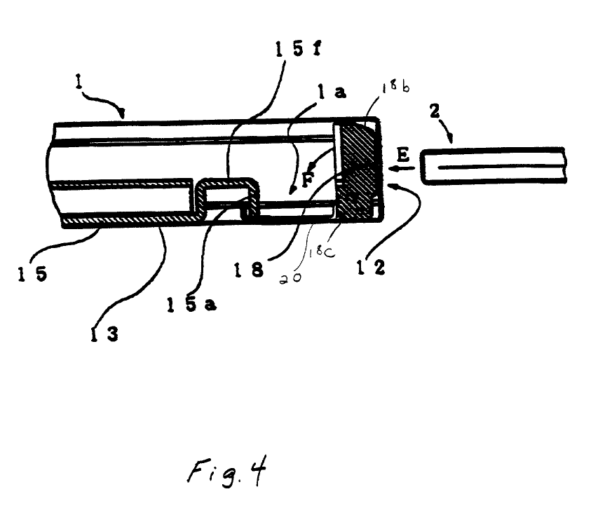

FIGS. 4 and 4A illustrate the details of cartridge access opening 12 and door 18. [CHECK WITH INVENTOR—need illustration of door from the perspective of its width] The bottom end of door 18 is coupled to lower casing 13 in a manner that allows door 18 to rotate inward, as indicated by arrow F in FIG. 4. Door 18 is preferably held in place by an attachment piece 20. Attachment piece 20 grasps a plurality of mounting pins 18a integrally formed in door 18, in effect hinging door 18 to attachment piece 20. This mounting arrangement allows door 18 to span substantially the entire width of data storage device 1. Attachment piece 20 is secured by frame 15 in the manner illustrated in FIG. 4. A spring (not shown) biases door 18 in the closed position, i.e., the position shown in FIG. 4, when data storage cartridge 2 is not installed in device 1.

Door 18 spans substantially the entire height, i.e., thickness, of data storage device 1. In a preferred embodiment, the height of door 18 is about 5 mm. (Throughout this specification, unless otherwise noted, references to door 18 are based on the door's “closed” position.) Preferably, the clearance between the upper and lower surfaces of door 18 and the adjacent surfaces of casing halves 13 and 14 is about zero, i.e., door 18 preferably abuts casing halves 13 and 14. Door 18 is made of a relatively strong and rigid material, preferably metal, hard plastic, or plastic with a metallic insert. In a preferred embodiment, the thickness of door 18, i.e., the dimension of door 18 corresponding to the longitudinal (x) axis of device 1, is about yy mm. [CHECK WITH INVENTOR]

The close proximity of door 18 to casing halves 13 and 14, combined with the door's strength and rigidity, allow door 18 to function as a structural member. Specifically, door 18 provides data storage device 1 with significant resistance to bending moments about the device's longitudinal axis. Furthermore, door 18 protects casing halves 13 and 14 from being crushed when device 1 is exposed to excessive vertical and side loading as, for example, when the device is dropped or when another object is dropped or placed on the device. Door 18 thus enhances the durability of relatively small and thin data storage devices by providing such devices with the ability to resist externally-applied forces without significant deformation or damage.

Door 18 also isolates the interior of device 1 from dust, dirt and other foreign objects during periods in which data storage cartridge 2 is not installed in the device. Furthermore, door 18 performs the aforementioned functions without causing the dimensions of device 1 to exceed those of the PCMCIA Type-II form factor.

Frame 15 contains a bend 15a adjacent to disk access opening 12. As indicated in detail in FIG. 4, a portion of bend 15a forms the shape of an inverted “U.” Bend 15a provides the frame with substantial resistance to bending about the longitudinal axis. Additionally, the top surface of bend 15a forms a horizontal section 15f which guides data storage cartridge 2 into position as the cartridge is inserted into data storage device 1.

A door-receiving section la is formed by the gap between frame bend 15a and cartridge access opening 12. Insertion of disk cartridge 2 forcibly rotates door 18 in the direction F illustrated in FIG. 4, against the bias of a spring (not shown). Upper outer edge 18b and lower inner edge 18c of door 18 are rounded to facilitate the rotational movement of door 18. [CHECK WITH INVENTOR re rounding of lower inner edge]

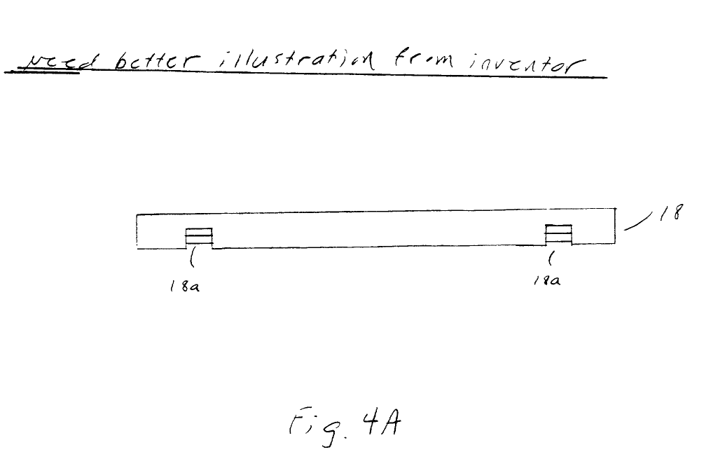

When door 18 reaches about 90 degrees of travel from the vertical position, the door is partially enclosed within section 1a. As shown in FIG. 5, while in this position door 18 forms a planar surface which is about level with cartridge guide section 15f. Thus, storing door 18 in the noted manner is conducive to the smooth installation of cartridge 2 into device 1. Furthermore, this configuration does not require any increase in the height or width of data storage device 1 beyond that needed to accommodate frame 15 and the device's other internal components.

Frame 15 is formed from a non-magnetic material, e.g., non-magnetic stainless steel. The thickness of frame 15 preferably spans a range of about 0.2 to 0.7 mm.

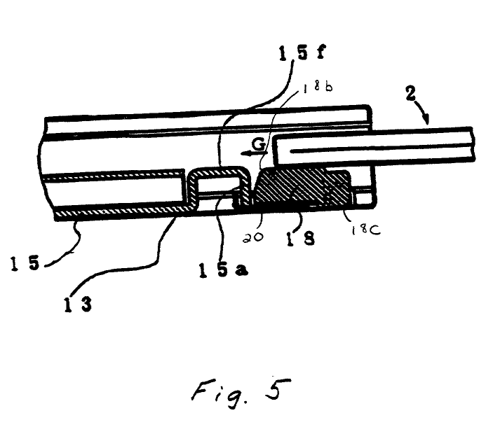

Frame 15 contains a shallow recess 15b, as illustrated in detail in FIGS. 6 through 8. Recess 15b is circular in shape, and is approximately centered on the longitudinal axis of data storage device 1. Recess 15b is preferably stamped into frame 15. Preferably, the diameter and depth of recess 15b are about 37 mm and 1.6 mm, respectively.

A disk-drive-motor attachment lip 15c is located in the center of frame recess 15b. As evident from FIG. 6, lip 15c extends upwardly from the surface of recess 15b, forming a cylindrical attachment point for motor 16. This mounting scheme allows the top of drive motor 16 to remain roughly level with the main surface of frame 15, while providing sufficient space below the main surface to accommodate the various component parts of the motor.

A bearing 16a of motor 16 is positioned within attachment lip 15c. A rotor shaft 16b is located within bearing 16a. A horizontally-oriented cartridge support section 16i is formed in rotor shaft 16b. Section 16i supports data storage cartridge 2 when the cartridge is installed in data storage device 1. Section 16i also functions as an attachment point for a rotor 16c and a disk-hub coupling magnet 16d.

Rotor 16c is formed in the shape of a shallow cylindrical cup, and is placed on support section 16i in inverted position. A plurality of rotor magnets 16e are placed along the inner circumference of rotor wall 16h. Disk-adhesion magnet 16d is mounted on the top surface of rotor-shaft support section 16i such that the top surface of magnet 16d extends slightly higher than the surface of rotor 16.

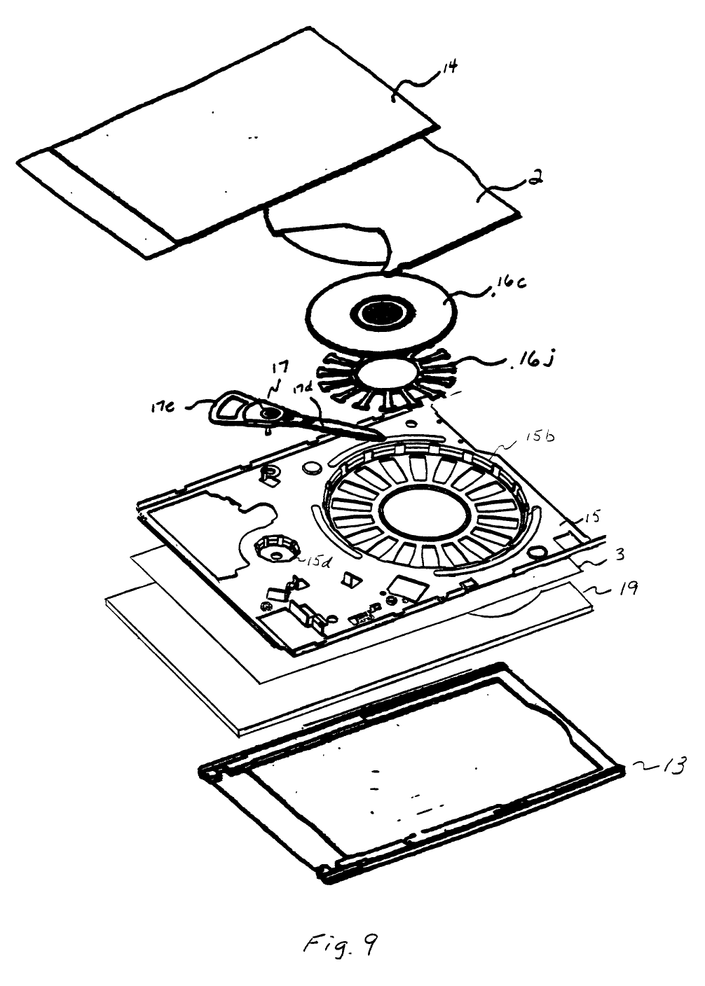

An assembly 16j contains a plurality of yoke members 16f arranged in a radial pattern about a center ring, as illustrated in FIG. 9. Yoke-member assembly 16j is made of a material which is capable of magnetization. The inner ring of assembly 16j is affixed to the exterior of attachment lip 15c, resulting in a circular arrangement of yoke members 16f about the center of frame recess 15b. As evident in FIG. 6, each yoke member 16f spans substantially the entire radius of recess 15b, thus placing the end of each member in a location proximate to disk drive magnets 16e.

A stator coil 16g is attached to each yoke member 16f. Coils 16g are electrically connected to an electronic control circuit (not shown). The bottom section of each coil is accommodated by an opening 15h in frame recess 15b, as illustrated in FIGS. 6 through 8. The flow of electrical current through coils 16g produces a rotational force on rotor 16c. Thus, by selectively sending current through coils 16g, the control circuit can vary the rotational position of a data storage disk 22 placed on rotor 16c.

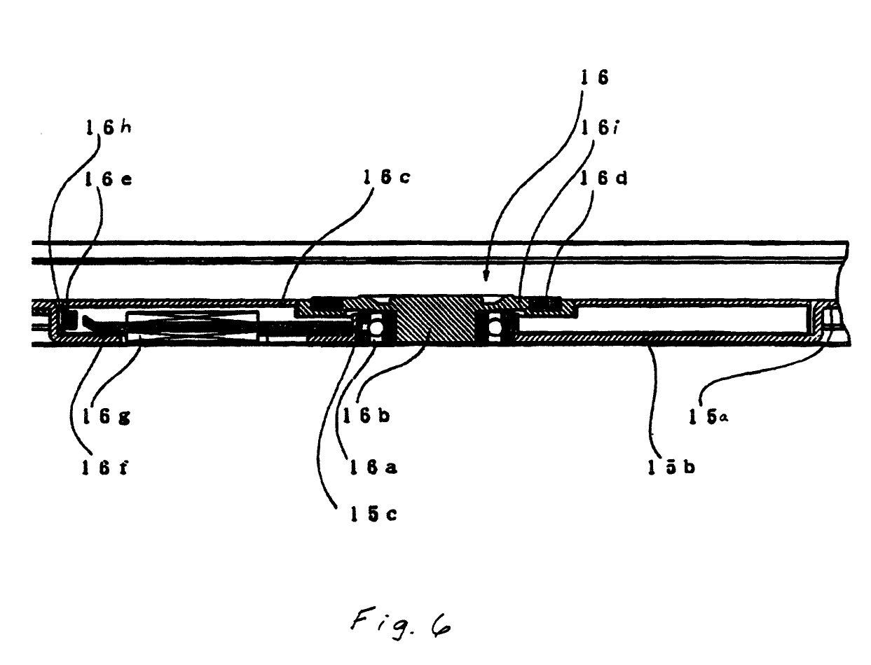

FIGS. 7 through 10 illustrate another shallow recess 15d formed in frame 15. Like recess 15b, recess 15d is circular in shape and is preferably stamped into frame 15. Recess 15d accommodates the supporting structure for read/write head assembly 17. Preferably, the diameter and depth of recess 15d are about 7 and 1.6 mm, respectively. The center-to-center distance between recesses 15b and 15d is preferably about 32 mm along the longitudinal axis, and about 3 mm along the lateral (y) axis of frame 15.

A downward-extending cylindrical attachment lip 15e is formed in the center of recess 15d. Lip 15e functions as an attachment point for head assembly 17. A shaft 17b is positioned within attachment lip 15e. Two bearings 17a are placed on shaft 17b. A base 17c for head assembly 17 is placed over bearings 17a.

An arm 17d and a stator coil 17e are fixed to base 17c. Coil 17e is electrically connected to a control circuit (not shown). Arm 17d is formed from a long, extended steel plate. Read/write head 17i is attached to the opposite end of arm 17d.

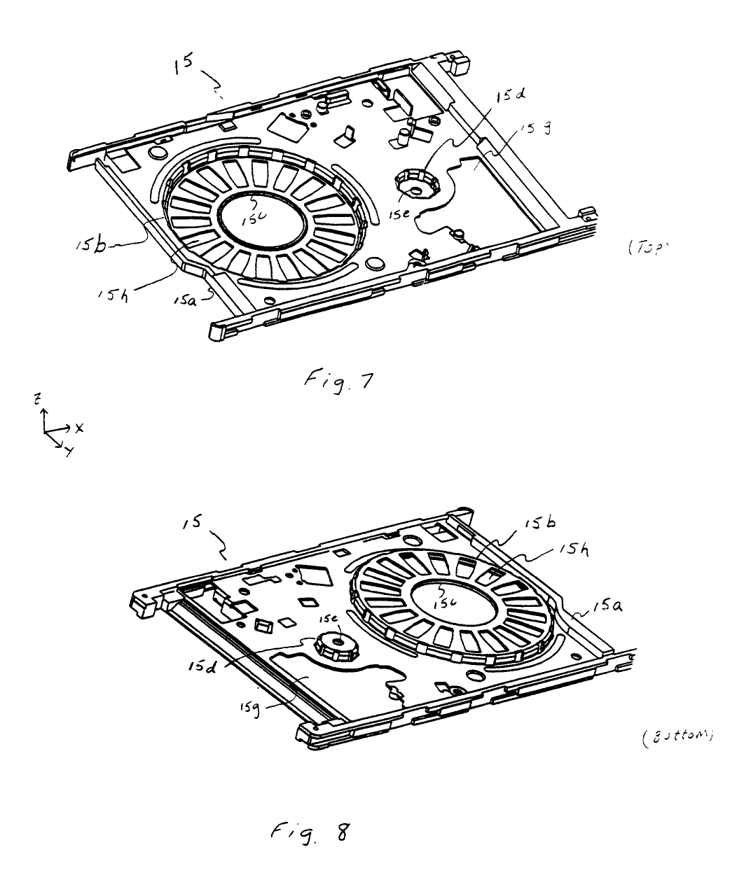

An arc-shaped lower head-yoke 17f is fixed within an opening 15g in frame 15. As evident in FIGS. 7 and 8, opening 15g is located directly adjacent to frame recess 15d. Integrating yoke 17f into frame 15 in this manner, as opposed to attaching the yoke to the top surface of the frame, reduces the height, i.e., thickness, of data storage device 1.

A head-drive magnet 17h is fixed to the top surface of yoke 17f. Magnet 17h faces the lower surface of a stator coil 17e. An upper yoke 17g is attached to frame 15 such that the bottom surface of yoke 17g faces the upper surface of coil 17e, as shown in FIG. 2. Yokes 17f and 17g are made of magnetic materials, or materials which are capable of magnetization. Thus, the application of current through coil 17e results in a force which moves the coil through a circular arc. Since coil 17e is connected to read/write head 17i through base 17c and arm 17d, movement of the coil produces a corresponding movement of head 17i. Hence, by selectively sending current through coil 17e, the position of read/write head 17i can be varied in relation to data storage disk 22.

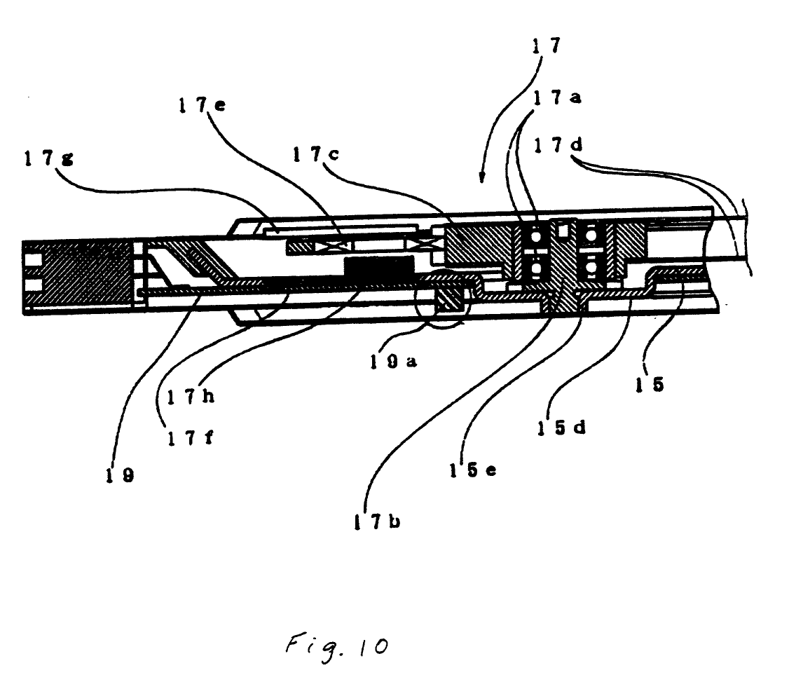

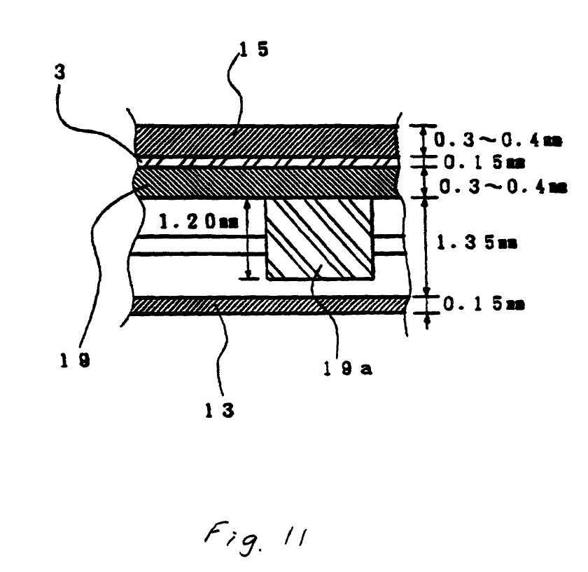

Circuit board 19 is mounted to the underside of frame 15, as illustrated in FIG. 10. As noted previously, insulating sheet 3 is interspersed between frame 15 and circuit board 19. Due to the presence of frame recesses 15b and 15d, a clearance of about 1.35 mm exists between the bottom surface of frame 15 and lower casing 13. A 1.20-mm thick integrated circuit 19a can thus be accommodated without any increase in the thickness of data storage device 1, as illustrated in FIG. 11. Hence, the need and expense of developing a specially-developed integrated circuit are obviated.

As evident from the above discussion, the invention embodies a substantially continuous frame 15 for mounting the primary components of data storage device 1. The use of a single frame 15 increases the rigidity of data storage device 1 relative to devices which use multi-piece frames or no frames at all. Additionally, recesses 15b and 15d, by virtue of their geometry and integration into frame 15, provide further resistance to bending about the lateral and longitudinal axes of device 1. Frame 15 thus enhances the durability of relatively small and thin data storage devices by providing such devices with the ability to resist externally-applied forces without significant deformation or damage.

As noted previously, recesses 15b and 15d provide a means for mounting the primary components of data storage device 1 in a manner which minimizes the thickness of the device, thereby allowing the device to fit within a form factor conforming to the PCMCIA type-II standard. Hence, frame 15 makes a small, portable data storage device feasible from the standpoint of minimizing the size of the device without decreasing the device's durability. Additionally, the placement of frame bend 15a between disk drive motor 16 and cartridge access opening 12 allows the bend to be used a guide for data storage cartridge 2, thereby facilitating smooth insertion of the cartridge. Finally, manufacturing frame 15 by a stamping process allows drive motor 16 and read/write head 17i to be positioned with great accuracy, thereby enhancing the reliability of data storage device 1.

The above description of the preferred embodiment is not intended to impliedly limit the scope of protection of the following claims. Therefore, the following claims are not limited to applications involving, for example, PCMCIA-type data storage devices for computers.

What is claimed is:

1. A data storage device comprising:
a casing having an opening through which a data storage cartridge is inserted;
a door coupled to said casing, said door covering said opening when said data storage cartridge is not installed in said device, said door forming a load-bearing structural element of said device.

2. The data storage device of claim 1, wherein said door is coupled to said casing such that said door rotates upon an insertion of said data storage cartridge into said data storage device.

3. The data storage device of claim 2, further comprising a spring, said spring biasing said door toward a closed position.

4. The data storage device of claim 2, wherein said door rotates towards an interior of said casing.

5. The data storage device of claim 2, wherein said door rotates through an arc of about 90 degrees.

6. The data storage device of claim 1, wherein an upper surface of said door substantially abuts said casing.

7. The data storage device of claim 1, wherein a lower surface of said door substantially abuts said casing.

8. The data storage device of claim 1, wherein said door forms a planar surface which guides said data storage cartridge during an insertion of said data storage cartridge into said data storage device.

9. The data storage device of claim 2, wherein said door is forcibly rotated by said data storage cartridge during said insertion of said data storage cartridge.

10. The data storage device of claim 1, wherein said door comprises a plurality of mounting pins integrally formed in said door.

11. The data storage device of claim 10, further comprising a door attachment piece coupled to said casing and said door mounting pins.

12. The data storage device of claim 11, wherein said door attachment piece is hinged to said door mounting pins.

13. The data storage device of claim 11, wherein said door attachment piece is coupled to a lower half of said casing.

14. The data storage device of claim 1, wherein a height of said door is about 5 mm.

15. The data storage device of claim 1, wherein a thickness of said door is about xx mm. [CHECK WITH INVENTOR]

16. The data storage device of claim 1, wherein said door spans substantially an entire width of said device.

17. The data storage device of claim 1, wherein said door is made of a plastic material.

18. The data storage device of claim 17, wherein said door comprises a metallic insert.

19. The data storage device of claim 1, wherein said door is made of a metallic material.

20. The data storage device of claim 1, wherein one or more edges of said door are rounded.

21. The data storage device of claim 1, further comprising a frame mounted within said casing.

22. The data storage device of claim 21, wherein said frame comprises a bend in a longitudinal end of said frame, and said door is positioned between said frame bend and a proximal longitudinal end of said casing when said data storage cartridge is installed in said data storage device.

23. The data storage device of claim 22, wherein said door forms a planar surface of about the same height as said frame bend when said data storage cartridge is installed in said device.

24. The data storage device of claim 21, further comprising:
a disk-drive motor which causes a storage medium located inside of said data storage cartridge to rotate;
a read/write head which stores and reads information to and from said storage medium; and
a head-drive motor which moves said read/write head to and from a location proximate said storage medium, said disk-drive motor, read/write head, and head drive motor coupled to said frame.

25. The data storage device of claim 1, wherein said casing has the shape and dimensions conforming to the PCMCIA Type-II form factor.
